(19) United States
(12) Patent Application Publication
(10) Pub. No.: US 2008/0174607 A1
(43) Pub. Date: Jul. 24, 2008

(54) SYSTEMS AND METHODS FOR REDUCING POWER CONSUMPTION IN A DEVICE THROUGH A CONTENT ADAPTIVE DISPLAY

(76) Inventor: Ali Iranli, San Diego, CA (US)

Correspondence Address: QUALCOMM INCORPORATED, 5775 MOREHOUSE DR., SAN DIEGO, CA, 92121, US

(21) Appl. No.: 11/626,580

(22) Filed: Jan. 24, 2007

(51) Int. Cl. G09G 3/36; G02F 1/13357

(52) U.S. Cl. 345/589; 345/102

(57) ABSTRACT

A method for reducing power consumption in a device through a content adaptive display is described. A frame of an image is received. A backlight value is calculated. A scaling factor is calculated. The backlight value is applied to a backlight. The scaling factor is applied to a matrix of pixels to obtain a scaled matrix of pixels. The scaled matrix of pixels is displayed.

### TECHNICAL FIELD

The present systems and methods relate generally to computers and computer-related technology. More specifically, the present systems and methods relate to reducing power consumption in a device through a content adaptive display.

### BACKGROUND

Electronic devices typically include a display. A display type may use a liquid crystal display (LCD) because of its low-cost, readability and low power consumption. Without a backlight, an LCD has poor readability with low ambient light levels. An LCD may include a backlight to light the display and thereby enhance readability. A backlight, which is typically an incandescent light, consumes more electrical power than the LCD itself. A typical portable electronic device is battery-powered. Conservation of battery power is important to increase the operating duration of the device. Activating the backlight for the LCD display consumes a significant amount of battery power and therefore decreases the operating time of the device.

### BRIEF DESCRIPTION OF THE DRAWINGS

FIG. 1 is a block diagram illustrating one configuration of a display device;

FIG. 1A is a block diagram illustrating one configuration of displaying an image implementing an adaptive backlight control algorithm;

FIG. 2 is a flow diagram illustrating one aspect of a method for reducing power consumption by a device;

FIG. 3 is a block diagram illustrating one configuration of an architecture of a general system when an adaptive backlight control is active;

FIG. 4 is a flow diagram illustrating a method of implementing an adaptive backlight control algorithm;

FIG. 5 illustrates one feature of transforming a histogram associated with an input frame;

FIG. 6 illustrates one configuration of a chart indicating power consumption of light emitting diodes for various backlight levels;

FIG. 7A is one configuration of a histogram illustrating an image categorization of a low key image;

FIG. 7B is another configuration of the histogram to further categorize a low key image as a long tail or a short tail;

FIG. 7C is one configuration of a histogram that may be used to categorize an image as a high key image;

FIG. 7D is one configuration of a histogram that may be used to categorize an image as a wide image; and

FIG. 8 is a block diagram of certain components in one configuration of a communication device.

### DETAILED DESCRIPTION

A method for reducing power consumption in a device through a content adaptive display is described. A frame of an image is received. A backlight value is calculated. A scaling factor is calculated. The backlight value is applied to a backlight. The scaling factor is applied to a matrix of pixels to obtain a scaled matrix of pixels. The scaled matrix of pixels is displayed.

An apparatus for reducing power consumption through a content adaptive display is also described. The apparatus includes a processor and memory in electronic communication with the processor. Instructions are stored in the memory. The instructions are executable to: receive a frame of an image; calculate a backlight value; calculate a scaling factor; apply the backlight value to a backlight; apply the scaling factor to a matrix of pixels to obtain a scaled matrix of pixels; and display the scaled matrix of pixels.

A system that is configured to reduce power consumption in a device through a content adaptive display is also described. The system includes a means for processing and a means for receiving a frame of an image. A means for calculating a backlight value and a means for calculating a scaling factor are also described. A means for applying the backlight value to a backlight and a means for applying the scaling factor to a matrix of pixels to obtain a scaled matrix of pixels are also described. A means for displaying the scaled matrix of pixels is also described.

A computer readable medium is also described. The medium is configured to store a set of instructions executable to: receive a frame of an image; calculate a backlight value; calculate a scaling factor; apply the backlight value to a backlight; apply the scaling factor to a matrix of pixels to obtain a scaled matrix of pixels; and display the scaled matrix of pixels.

Various configurations of the present systems and methods are now described with reference to the Figures, where like reference numbers indicate identical or functionally similar elements. The aspects of the present systems and methods, as generally described and illustrated in the Figures herein, could be arranged and designed in a wide variety of different configurations. Thus, the following more detailed description of several configurations of the present systems and methods, as represented in the Figures, is not intended to limit the scope of the systems and methods, as claimed, but is merely representative of the aspects of the systems and methods.

Many features of the configurations disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present systems and methods.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “a configuration,” “configuration,” “configurations,” “the configuration,” “the configurations,” “one or more configurations,” “some configurations,” “certain configurations,” “one configuration,” “another configuration” and the like mean “one or more (but not necessarily all) configurations of the disclosed systems and methods,” unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Power saving may be a constant concern for portable electronic or mobile devices. Power may be saved while not significantly reducing the quality of operation or service of the device. In one configuration, a backlight of a liquid crystal display (LCD) consumes a large amount of power of the device. The LCD display may consume from about 30% to 50% of the total power of the device depending on the status of the device. Backlight scaling may be used to reduce the amount of backlight for the LCD display while minimizing its impact on the perceived brightness and distortion on the display. The scaling process may be adaptive in order to accommodate for the frequent change of content on the LCD display.

Luminance of the LCD display may be a function of the luminance of the backlight and the transmittance of an LCD matrix. The luminance of the LCD display may be represented by:

L=t(x)bl (1)

In the above equation, L may represent the luminance of the LCD display, bl may represent the luminance of the backlight and t(x) may represent the transmittance of the LCD matrix. The transmittance of the LCD matrix may be approximated as a function of a pixel grayscale level x. A display may have the same luminance when the backlight is scaled down (dimmed) by a factor, β, while the transmittance (or value of one or more pixels) of the LCD matrix is scaled up by a factor, τ. In one configuration, τ=1/β. In another configuration, τ=(1/β)^{(1/γ)}, where γ is the display characteristic parameter.

The power of the backlight may be a function of its luminance (i.e., brightness). In portable or mobile devices, backlight brightness may be controlled through a Pulse Width Modulation (PWM) method, which makes brightness a linear function of backlight power. By reducing the backlight by a factor of β, the overall display may consume less power by a factor close to β.

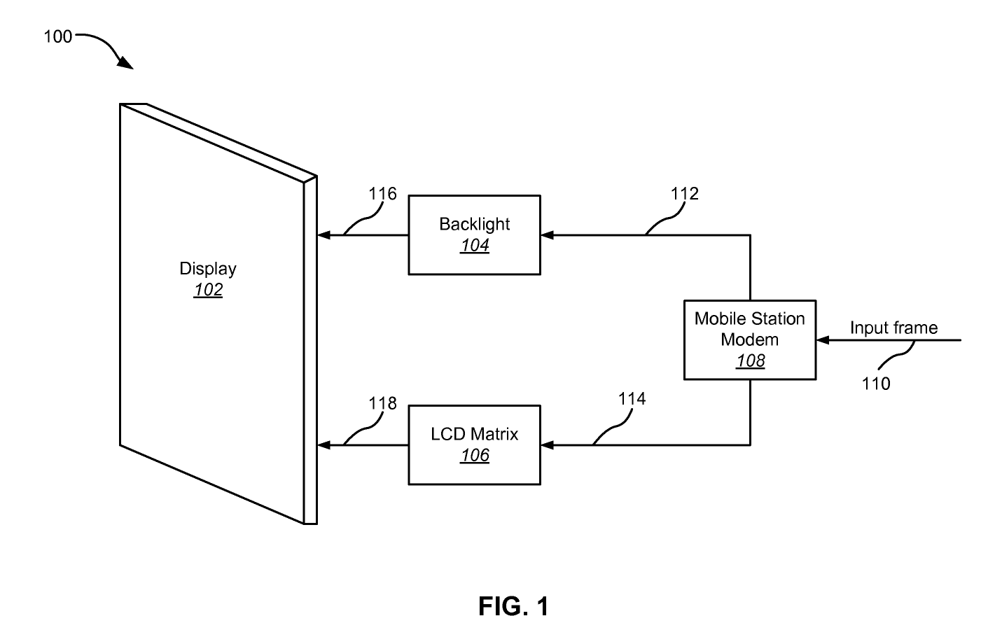

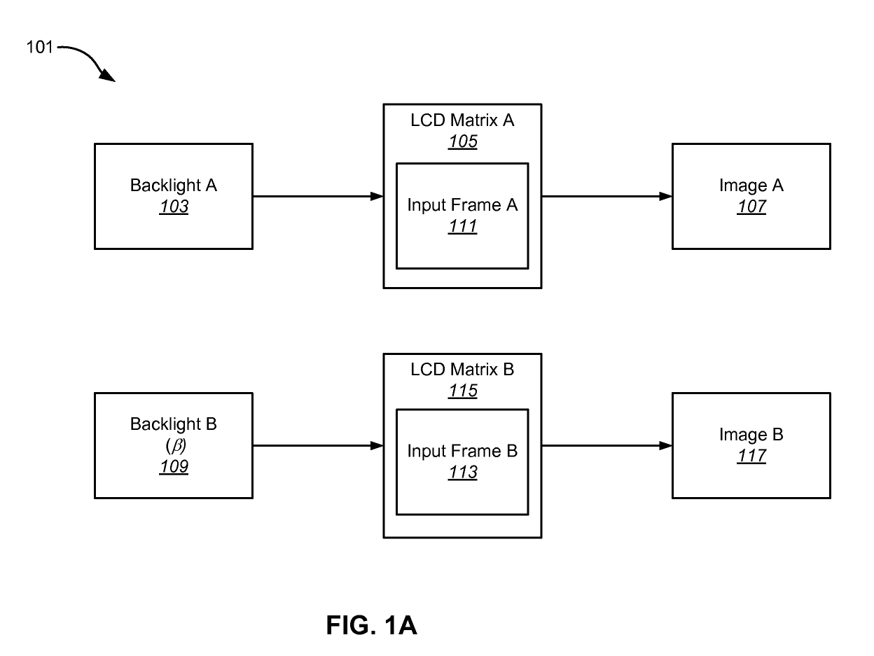

FIG. 1 is a block diagram illustrating one configuration of a display device 100. The device 100 may include a display 102. The display 102 may be an LCD. The display 102 may portray pixels which form an image. An input frame 110 may be provided to a Mobile Station Modem (MSM) 108. The input frame 110 may include a single frame of an image. In one aspect, the MSM 108 processes the input frame 110 and communicates a backlight value 112 to a backlight 104. The backlight 104 may emit a light source 116 that may be used to brighten the pixels on the display 102. The backlight 104 may use the backlight value 112 to determine the intensity of the brightness of the light source 116. For example, a higher backlight value may indicate an increase in the brightness intensity of the light source. A higher intensity of the brightness may provide a brighter image on the display 102.

The MSM 108 may also communicate a scaling factor 114 to an LCD matrix 106. The LCD matrix 106 may include the pixels associated with the input frame 110 arranged in a matrix formation. In one configuration, each pixel within the LCD matrix 106 may include a value for different colors. For example, a single pixel may include a value for each color of red, blue and green. The scaling factor 114 may be used to determine the intensity of each color value associated with a pixel. For example, the scaling factor 114 may indicate that the value for the color red should be increased for one or more pixels within the LCD matrix 106. An adjusted LCD matrix 118 may be portrayed on the display 102. In one configuration, the LCD matrix 106 may include multiple input frames which may each be adjusted to an adjusted LCD matrix 118 and placed on the display 102 to form an image.

FIG. 1A is a block diagram 101 illustrating one configuration of displaying an image implementing an adaptive backlight control algorithm. In one configuration, image A 107 may be displayed without the adaptive algorithm. For example, backlight A 103 may emit a light source to illuminate LCD matrix A 105. LCD matrix A 105 may include input frame A 111, made up of one or more pixels. The value of each pixel may be a function of (x). The light source from backlight A 103 may illuminate input frame A 111 in LCD matrix A 105 to produce image A 107. Image A 107 may be displayed on a display, such as display 102.

In another configuration, backlight B 109 may emit a light source that has been altered by a function of (β). The function of (β) may cause the light source to include a brightness of less intensity than the light source emitted from backlight A 103. The light source from backlight B 408 may illuminate LCD matrix B 115 which includes input frame B 113. Input frame B 113 may be made up of one or more pixels. The original value of each pixel may be a function of (x). In one configuration, the value of each pixel in input frame B 113 may be altered by a scaling factor. In one configuration, the scaling factor is a function of (x, β). In other words, the scaling factor may be a function of the brightness intensity of the light source emitted from backlight B 109. The emitted light source from backlight B 109 may illuminate LCD matrix B 115 to produce image B 117. Image B 117 may be displayed on a display, such as display 102.

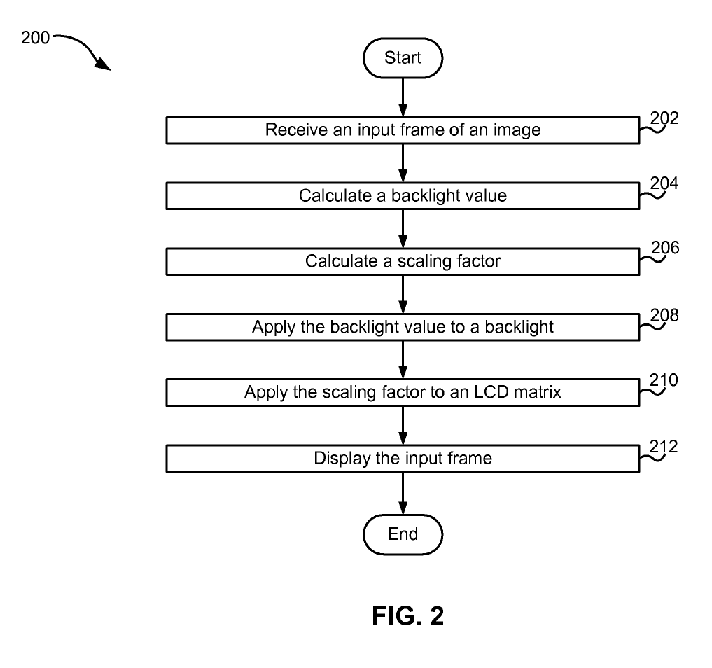

FIG. 2 is a flow diagram illustrating one aspect of a method 200 for reducing power consumption in a device through a content adaptive display. In one configuration, an input frame of an image is received 202. The MSM 108 may receive and process the input frame. A backlight value may be calculated 204. As previously mentioned, the backlight value may indicate the intensity of the light source used to illuminate an image on a display. In one configuration, a scaling factor may be calculated 206. The scaling factor may indicate whether the value of one or more pixels should be increased or decreased.

The previously calculated backlight value may be applied 208 to a backlight. The backlight may use the backlight value to alter the brightness intensity of a light source. In addition, the previously calculated scaling factor may be applied 210 to a matrix of pixels, such as an LCD matrix. The LCD matrix may use the scaling factor to alter the brightness intensity of one or more values associated with one or more pixels in the LCD matrix. In one configuration, the input frame is displayed 212 on a display. The displayed input frame may include an adjusted LCD matrix that has been adjusted by the scaling factor. The displayed input frame may also be illuminated by the light source emitted from the backlight. The light source may include the brightness intensity indicated by the calculated backlight value.

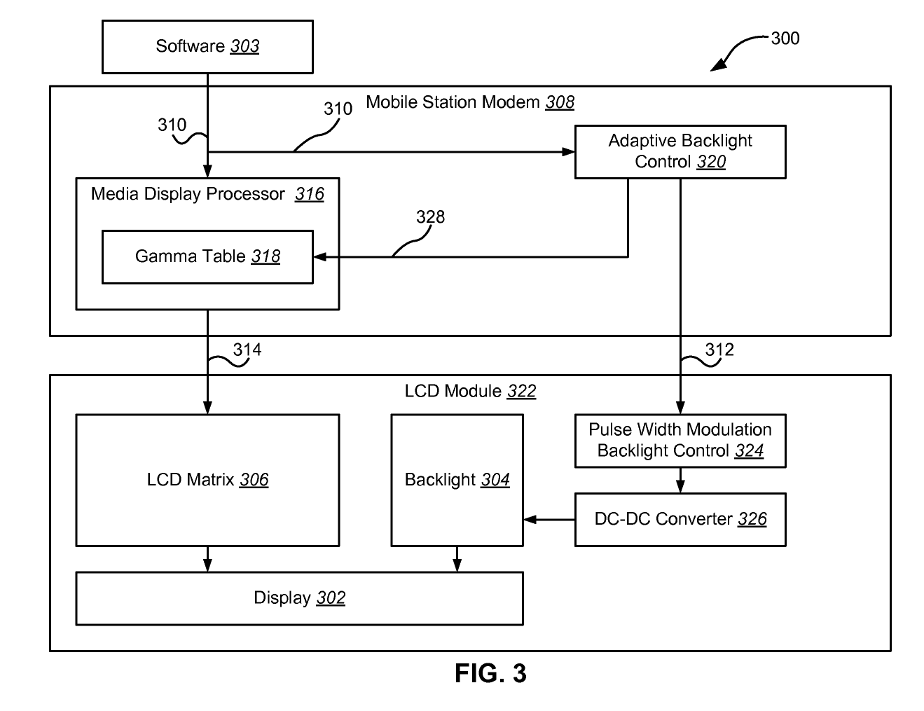

FIG. 3 is a block diagram illustrating one configuration of the architecture of a general system 300 when an adaptive backlight control 320 is active. The adaptive backlight control 320 may include an adaptive backlight algorithm that is used to calculate a backlight value 312. The adaptive backlight algorithm may be independent of the resolution and size of a display.

In one configuration, software 303 may write an input frame 310 of an image to a media display processor (MDP) 316, which may be part of an MSM 308. The MDP 316 may use the input frame 310 to update a display 302. The adaptive backlight control 320 may also receive the input frame 310. In one configuration, the input frame 310 is “snooped” by the adaptive backlight control 320 when the software 303 writes this frame 310 to the MDP 316. The adaptive backlight control 320 may calculate a backlight value 312 for the input frame 310. The backlight value 312 may indicate the minimum brightness intensity that may be used to illuminate the input frame 310 on the display. The backlight value 312 may be provided to an LCD module 322. The module 322 may include a pulse width modulation (PWM) backlight control 324. The PWM 324 may control the brightness of a light source emitted from a backlight 304. The PWM 324 may communicate the backlight value 312 to a direct current (DC)-DC converter 326. The DC-DC converter 326 may convert the backlight value 312 into a format that is readable by the backlight 304. The backlight 304 may then emit a light source to the display 302. The light source may be adjusted to the brightness intensity indicated by the backlight value 312.

The adaptive backlight control 320 may also provide gamma table information 328 to the MDP 316. The gamma table information 328 may include information relating to the backlight value 312. In one configuration, the gamma table information 328 may be provided to a gamma table 318. The gamma table 318 may include a programmable look up table (LUT). The gamma table 318 may use the gamma table information 328 to determine a scaling factor 314 that is communicated to an LCD matrix 306. The LCD matrix 306 may include the input frame 310. The scaling factor 314, as previously stated, may indicate a value for the one or more pixels of the input frame 310 in the LCD matrix 306. The LCD matrix 306 may use the scaling factor 314 to adjust the one or more pixels and an adjusted input frame may be portrayed by the display 302. In another configuration, the scaling factor 314 may be communicated directly to the LCD module 322. The module 322 may then be instructed to apply the scaling factor 314 to individual LCD matrix points within the LCD matrix 306.

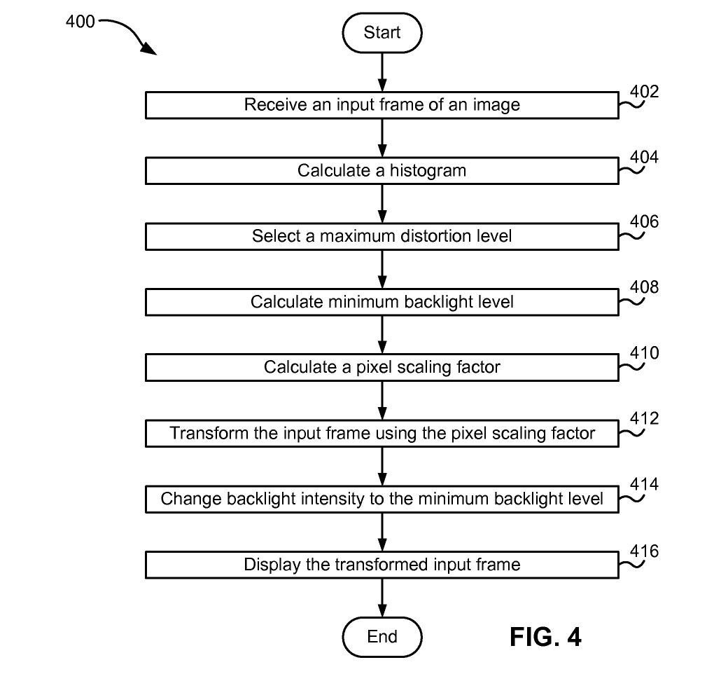

FIG. 4 is a flow diagram illustrating a method 400 of implementing an adaptive backlight control algorithm. In one configuration, an input frame of an image is received 402. The input frame may represent a single frame of the image. A histogram may be calculated 404. The histogram may indicate the quantity of pixels in the input frame that correspond to a particular value. For example, the histogram may indicate how many pixels correspond to a certain value on a grayscale. Values on the grayscale typically include shades of gray, varying from black at the weakest intensity to white at the strongest. However, the value may include shades of any color, or even coded with various colors for different intensities.

In one configuration, the information provided from the histogram may be used to select 406 a maximum distortion level for the input frame. The maximum distortion level may be selected 406 by categorizing the image. For example, the image may be categorized as low key images with short or long tails, wide images or high key images with short or long tails. In one configuration, information available in an image histogram may be utilized to obtain the image categorization. Based on this available information, the maximum distortion level may be found for an algorithm. The maximum distortion level may indicate the amount of distortion that a particular image may possess without significantly altering the visual aspects of the image.

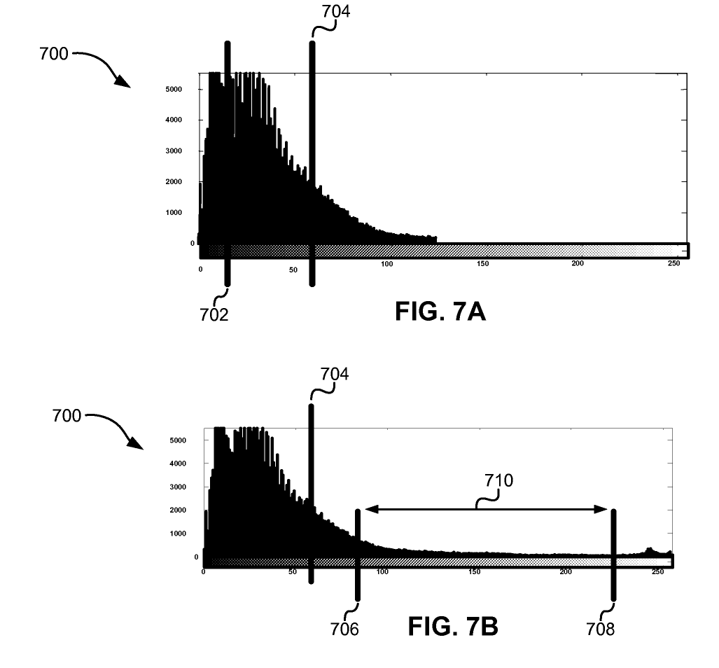

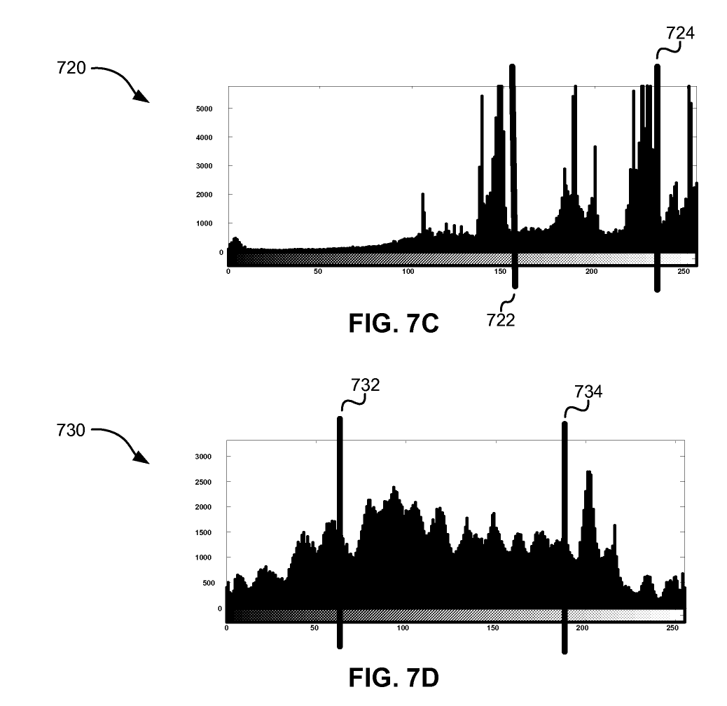

Image categorization may utilize different quintiles of an image based on its histogram. FIG. 7A is one configuration of a histogram 700 illustrating an image categorization of a low key image. A 25% quintile (Q25%) 702 and a 75% quintile (Q75%) 704 are located on the histogram 700 and if Q25% 702 is less than ⅓ of a grayscale range of the image and Q75% 704 is less than ½ of a grayscale range of the image, then the image may be categorized as a low key image. The ranges of 25%, 75%, ⅓ and ½ are used merely as examples. Other ranges may be utilized to categorize an image.

FIG. 7B is another configuration of the histogram 700 to further categorize a low key image as a long tail or a short tail. In one aspect, to categorize an image as short tail, pixels located in a high 25% quintile are evaluated. Pixels located in the high 25% quintile may include the pixels located to the right of Q75% 704. In one configuration, an upper 25% quintile (Q_U25%) 706 and an upper 75% quintile (Q_U75%) 708 may be calculated. A distance 710 between the Q_U25% 706 and the Q_U75% 708 may be measured. If the distance 710 is greater than ⅓ of the image grayscale range, the image may be categorized as a low key long tail image. Otherwise, the image may be categorized as a low key short tail image. The ranges of 25%, 75%, ⅓ are used merely as examples. Other ranges may be utilized to categorize an image as short or long tail.

FIG. 7C is one configuration of a histogram 720 that may be used to categorize an image as a high key image. A 25% quintile (Q25%) 722 and a 75% quintile (Q75%) 724 may be found. In one aspect, if Q25% is greater than ½ a grayscale range of the image and Q75% is greater than ⅔ of a grayscale range of the image (i.e., possible shades in the image), the image may be categorized as a high key image. The ranges of 25%, 75%, ½ and ⅔ are used merely as examples. Other ranges may be utilized to categorize an image as a high key image. In one configuration, a high key image may further be categorized as a short or long tail image. The short or long tail categorization may be based on an inter-quintile distance of a lower 25% pixel value (i.e., pixel values which are located to the left of the Q25% 722).

FIG. 7D is one configuration of a histogram 730 that may be used to categorize an image as a wide image. A 25% quintile (Q25%) 732 and a 75% quintile (Q75%) 734 may be found. In one aspect, if Q25% is less than ⅓ a grayscale range of the image and Q75% is greater than ⅔ of a grayscale range of the image (i.e., possible shades in the image), the image may be categorized as a wide image. The ranges of 25%, 75%, ½ and ⅔ are used merely as examples. Other ranges may be utilized to categorize an image as a high key image. In one configuration, a high key image may further be categorized as a short or long tail image.

Categorizing 404 the image from a histogram may allow an algorithm to select 406 the maximum distortion level based on the image category. In one configuration, a long tail low key image may yield a maximum distortion level of 5%. In another configuration, a wide image may yield a maximum distortion level of 20%. In yet another configuration, a high key image may yield a maximum distortion level of 40%. Additional image categorization may yield a maximum distortion level of 10%. Once again, these values corresponding to the maximum distortion level are used merely as examples.

Using the maximum distortion level and the original values of the pixels included in the input frame, a minimum backlight level may be calculated 408. The minimum backlight level may indicate the minimum amount of light that is emitted from a backlight in order to properly illuminate the input frame. In one configuration, the perceived output distortion of the input frame may be less than the distortion level defined by a user.

Using the calculated minimum backlight level, a pixel scaling factor may be calculated 410. The pixel scaling factor may indicate the amount the pixels associated with the input frame that will be adjusted on the grayscale. For example, the pixel scaling factor may indicate that the input frame is adjusted to the right side of the grayscale, thus increasing the brightness intensity of each pixel. Alternatively, the pixel scaling factor may indicate that the input frame is adjusted to the left side of the grayscale, decreasing the brightness intensity of each pixel. In one configuration, the pixel scaling factor is calculated 410 as a function of the minimum backlight level. For example, the pixel scaling factor may indicate that the input frame should be adjusted on the grayscale to increase the brightness of each pixel in order to compensate for the decrease in the brightness intensity of the light source emitted from the backlight.

The input frame may be transformed 412 in accordance with the pixel scaling factor. In other words, the pixels of the input frame may increase or decrease in brightness. In addition, the brightness intensity of the light source emitted from the backlight may be changed 414 according to the calculated minimum backlight level. The transformed input frame may be displayed 416 by illuminating the frame with the backlight. In one configuration, the transformed frame is displayed on the display 102.

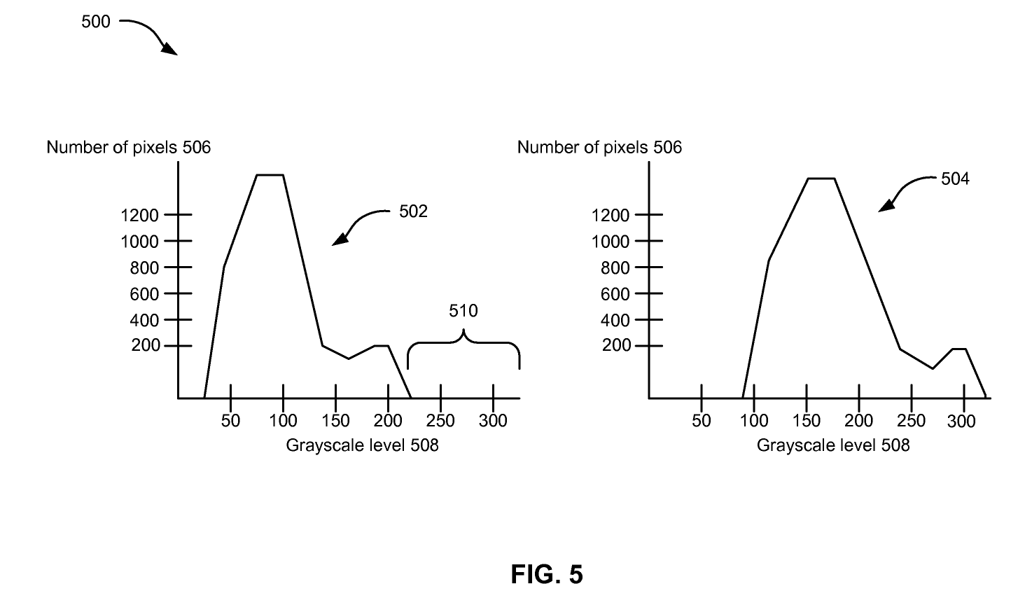

FIG. 5 illustrates one configuration 500 of transforming a histogram associated with an input frame. As previously mentioned, a histogram 502 may be calculated for an input frame. The histogram 502 may include number of pixels 506 and grayscale level 508 as the Y-axis and the X-axis, respectively. The number of pixels 506 indicates the quantity of pixels in the input frame that include an associated brightness on the grayscale level 508. For example, approximately 800 pixels on the histogram 502 may include a brightness on the grayscale level 508 of between 50 and 125. A zero value on the grayscale level 508 may indicate no brightness (or the color black).

In one configuration, the histogram 502 may be shifted by a scaling factor 510 amount to provide a transformed histogram 504. In other configurations, the histogram 502 may be transformed to the transformed histogram 504 by multiplication (i.e., scaling that spreads the histogram 502). In addition, monotonically increasing Affine transforms may also be applied to the histogram 502 in order to obtain the transformed histogram 504. The scaling factor 510 may be calculated as a function of the change in brightness intensity of the light source emitted from a backlight. In other words, the scaling factor 510 may be proportional to the change in brightness intensity of the light source. The transformed histogram 504 may be shifted to the right side of the grayscale level 508. The corresponding 800 pixels previously mentioned may now include a brightness on the grayscale level 508 of the transformed histogram 504 between 125 and 200. The transformed histogram 504, in the depicted configuration, may indicate that the pixels of the transformed histogram 504 may be brighter than the pixels indicated by the histogram 502.

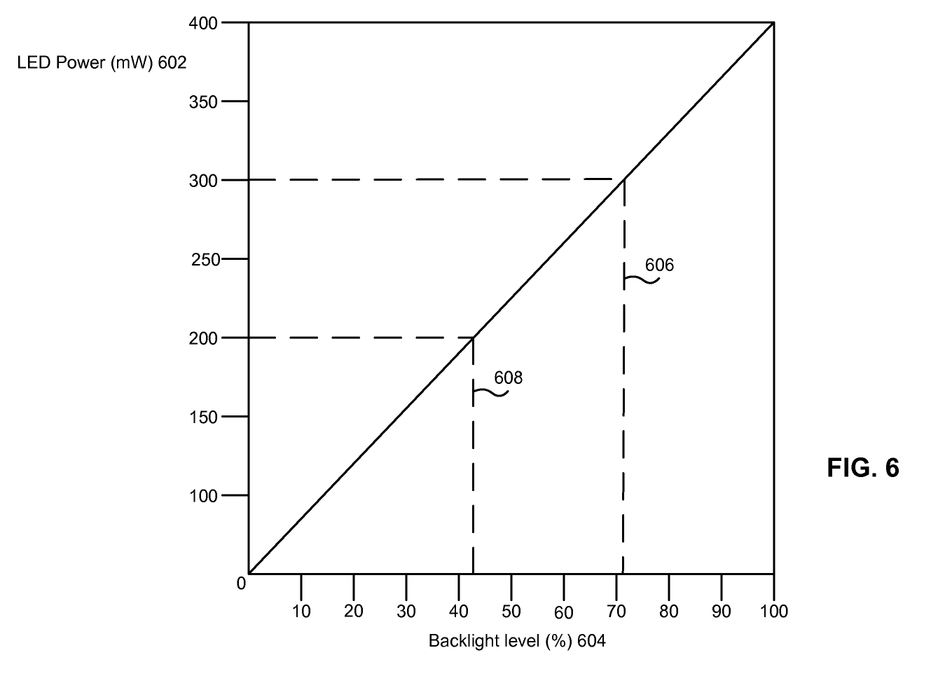

FIG. 6 is one configuration of a chart indicating power consumption 602 of light emitting diodes (LEDs) for various backlight levels 604. The backlight levels 604 may be represented as a percentage of full brightness intensity of a light source. Zero may indicate no brightness (or blackness) and 100% may represent full brightness intensity of the light source. A first backlight level 606 may include a brightness intensity of approximately 70% of full brightness intensity. As illustrated, a first level 606 with a brightness of 70% may cause LEDs to consume 300 milliwatts (mW) of power. A second backlight level 608 may include a brightness intensity of approximately 42% of full brightness capability. The second backlight level 608 may cause the LEDs to consume 200 mW of power. As illustrated, a decrease in backlight level 604 may proportionally decrease the power consumption 602.

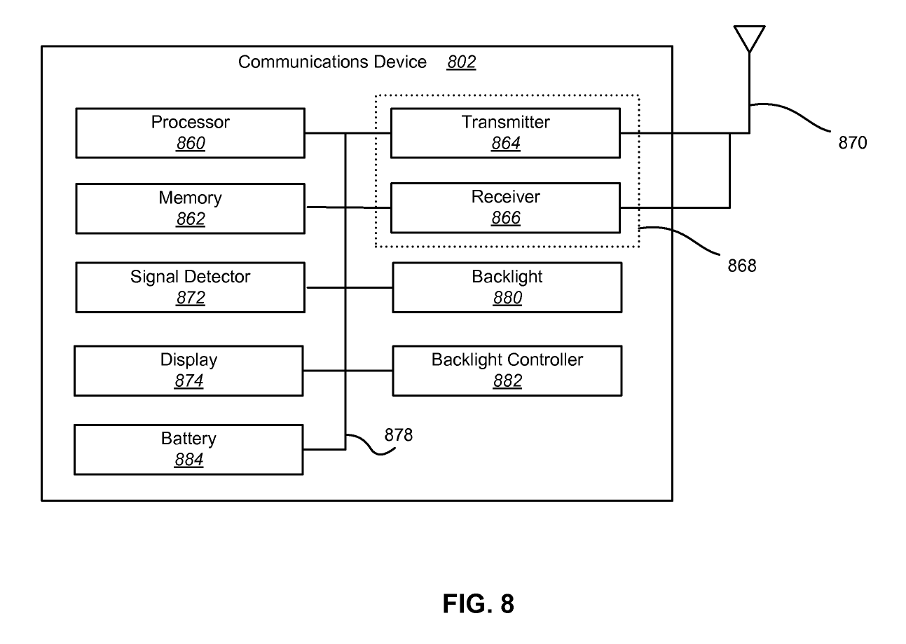

FIG. 8 is a block diagram of certain components in an example of a communications device 802. The present systems and methods may be implemented in an electronic device, which includes a communications device 802. The communications device 802 may be any type of apparatus such as, but not limited to, a personal digital assistant (PDA), a laptop computer, a digital camera, a music player, a game device, a mobile telephone or any other device with a processor 860.

As shown, the device 802 may include the processor 860 which controls operation of the device 802. A memory 862, which may include both read-only memory (ROM) and random access memory (RAM), may provide instructions and data to the processor 860. A portion of the memory 862 may also include non-volatile random access memory (NVRAM). Memory 862 may also include flash memory, an optical disk, registers, a hard disk, a removable disk, or any other types of memory.

The device 802, which may be embodied in a wireless communication device, such as a cellular telephone. The device 802 may also include a transmitter 864 and a receiver 866 to allow transmission and reception of data between the device 802 and a remote location. The transmitter 864 and receiver 866 may be combined into a transceiver 868. An antenna 870 is electrically coupled to the transceiver 868.

The device 802 may also include a signal detector 872 used to detect and quantify the level of signals received by the transceiver 868. The signal detector 872 detects such signals as total energy, pilot energy per pseudonoise (PN) chips, power spectral density, and other signals. The device 802 may also include a display 874 that may be used to display instructions to a user as well as user-entered data. In one configuration, the display 874 displays the time and date and calling party telephone number for incoming calls received by the transceiver 868. This information provides visual cues to the user and thereby assists the user in the operation of the device 802.

The device may include a backlight controller 882 to control a backlight 880 for the display 874. Various alternative configurations of the backlight controller 882 may be used to control the backlight 880 and reduce power consumption in the device 802. In addition, different display types may use a different form of lighting, such as side-lighting of an LCD or an LED display. The term “backlight” may encompass any form of display illumination whether it is the display itself or an external source.

Electrical components of the device 802 may receive power from a battery 884. The battery 884 may be a rechargeable battery. In other configurations, the device 802 may include a connector (not shown) for the connection of an external power source, such as an automobile power adapter, alternate current (AC) power adapter, or the like.

The various components of the device 802 are coupled together by a bus system 878 which may include a power bus, a control signal bus, and a status signal bus in addition to a data bus. However, for the sake of clarity, the various busses are illustrated in FIG. 8 as the bus system 878.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the configurations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present systems and methods.

The various illustrative logical blocks, modules, and circuits described in connection with the configurations disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the configurations disclosed herein may be embodied directly in hardware, in a software module executed by a processor, or in a combination of the two. A software module may reside in RAM memory, flash memory, ROM memory, erasable programmable read-only memory (EPROM), electrically erasable programmable read-only memory (EEPROM), registers, hard disk, a removable disk, a compact disc read-only memory (CD-ROM), or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present systems and methods. In other words, unless a specific order of steps or actions is required for proper operation of the configuration, the order and/or use of specific steps and/or actions may be modified without departing from the scope of the present systems and methods. The methods disclosed herein may be implemented in hardware, software or both. Examples of hardware and memory may include RAM, ROM, EPROM, EEPROM, flash memory, optical disk, registers, hard disk, a removable disk, a CD-ROM or any other types of hardware and memory.

While specific configurations and applications of the present systems and methods have been illustrated and described, it is to be understood that the systems and methods are not limited to the precise configuration and components disclosed herein. Various modifications, changes, and variations which will be apparent to those skilled in the art may be made in the arrangement, operation, and details of the methods and systems disclosed herein without departing from the spirit and scope of the systems and methods.

What is claimed is:

1. A method for reducing power consumption in a device through a content adaptive display, the method comprising:
receiving a frame of an image;
calculating a backlight value;
calculating a scaling factor;
applying the backlight value to a backlight;
applying the scaling factor to a matrix of pixels to obtain a scaled matrix of pixels; and
displaying the scaled matrix of pixels.

2. The method of claim 1, further comprising calculating a histogram of the frame.

3. The method of claim 2, wherein the histogram comprises a quantity of pixels associated with a value on a grayscale.

4. The method of claim 2, further comprising shifting the histogram on a grayscale.

5. The method of claim 4, wherein the amount of shift of the histogram is a function of a backlight value.

6. The method of claim 1, further comprising selecting a distortion level for the frame.

7. The method of claim 1, wherein the backlight value comprises the intensity of brightness of a light source emitted from the backlight.

8. The method of claim 1, wherein the scaling factor is a function of the backlight value.

9. The method of claim 1, wherein the scaling factor is selected from a gamma table which comprises a programmable look-up table (LUT).

10. The method of claim 1, wherein the scaled matrix of pixels is displayed on a liquid crystal display (LCD).

11. An apparatus for reducing power consumption through a content adaptive display, the apparatus comprising:
a processor;
memory in electronic communication with the processor;
instructions stored in the memory, the instructions being executable to:
receive a frame of an image;
calculate a backlight value;
calculate a scaling factor;
apply the backlight value to a backlight;
apply the scaling factor to a matrix of pixels to obtain a scaled matrix of pixels; and
display the scaled matrix of pixels.

12. The apparatus of claim 11, wherein the instructions are further executable to calculate a histogram of the frame.

13. The apparatus of claim 12, wherein the histogram comprises a quantity of pixels associated with a value on a grayscale.

14. The apparatus of claim 12, wherein the instructions are further executable to shift the histogram on a grayscale.

15. The apparatus of claim 14, wherein the amount of shift of the histogram is a function of a backlight value.

16. The apparatus of claim 11, wherein the instructions are further executable to select a distortion level for the frame.

17. The apparatus of claim 11, wherein the backlight value comprises the intensity of brightness of a light source emitted from the backlight.

18. The apparatus of claim 11, wherein the scaling factor is a function of the backlight value.

19. A system that is configured to reduce power consumption in a device through a content adaptive display comprising:
means for processing;
means for receiving a frame of an image;
means for calculating a backlight value;
means for calculating a scaling factor;
means for applying the backlight value to a backlight;
means for applying the scaling factor to a matrix of pixels to obtain a scaled matrix of pixels; and
means for displaying the scaled matrix of pixels.

20. A computer-readable medium configured to store a set of instructions executable to:
receive a frame of an image;
calculate a backlight value;
calculate a scaling factor;
apply the backlight value to a backlight;
apply the scaling factor to a matrix of pixels to obtain a scaled matrix of pixels; and
display the scaled matrix of pixels.
